(19) United States
(12) Patent Application Publication
(10) Pub. No.: US 2004/0259507 A1
(43) Pub. Date: Dec. 23, 2004

(54) Communication terminal

(76) Inventor: Erik Kohl, Langenau (DE)

Correspondence Address: BELL, BOYD & LLOYD, LLC, P. O. BOX 1135, CHICAGO, IL, 60690-1135, US

(21) Appl. No.: 10/490,983

(22) PCT Filed: Sep. 4, 2002
(86) PCT No.: PCT/EP02/09894

(30) Foreign Application Priority Data
Sep. 28, 2001 (EP) 01123500.9

(51) Int. Cl. H04B 1/38

(52) U.S. Cl. 455/90.3

(57) ABSTRACT

The invention relates to a communication terminal, comprising a transceiver circuitry for transmitting and/or receiving mobile radio signals and a housing at least partly encapsulating the transceiver circuitry, whereby the housing is made from an electrosensitive material, the optical properties of which change under the influence of electromagnetic radiation or/and an electrical field or/and an applied voltage.

The invention relates to a communication terminal, in particular a mobile radio terminal, comprising a transceiver circuitry for transmitting and/or receiving mobile radio signals and a housing at least partly encapsulating the transceiver circuitry.

When users are deciding to purchase a particular communication terminal, such as mobile radio terminals for example, visual and/or design characteristics are also influential in addition to the technical characteristics of the mobile radio terminals available on the market. For this reason, various manufacturers have gone over to offering their mobile radio terminals in different design variants, for example in such a way that different housing skins are offered for a particular mobile radio terminal, which can then be swapped to suit the taste of the user. In addition, an increasingly important factor influencing the decision of a user to purchase is the level of intensity of electromagnetic radiation emitted by the communication terminal he is using. It should be noted that, depending on the existing mobile radio network conditions, the mobile radio terminal transmits mobile radio signals at differing transmission power levels and thus emits differing levels of intensity of electromagnetic radiation. However, scarcely any provisions have as yet been made by the manufacturers for displaying the actual transmission power or the intensity of the electromagnetic radiation actually being emitted by a mobile radio terminal.

The object of the present invention is therefore to provide a communication terminal of the type described at the beginning which offers the user the capability to identify operating parameters that are dependent on transmission power whilst offering an attractive visual appearance.

This object is achieved by a communication terminal, in particular a mobile radio terminal, comprising a transceiver circuitry for transmitting and/or receiving mobile radio signals and a housing at least partly encapsulating the transceiver circuitry, whereby the housing consists of an electrosensitive material which changes its optical properties under the influence of electromagnetic radiation and/or an electrical field and/or an applied voltage.

By forming the housing from electrosensitive material it is possible to signal the transmission power actually being used to operate the communication terminal to the respective user solely by way of its visual appearance. The user can therefore decide on the basis of the visual appearance of his communication terminal whether he wishes to use this for example-in a position close to his head or whether he prefers to use the communication terminal at a location in which a lower transmission power is necessary. This state is signaled to the user by means of a different visual appearance, for example by means of a change in the color or the transparency of the housing.

It is basically possible to choose the electrosensitive material such that it changes its visual appearance depending on the intensity of electromagnetic radiation. It is equally possible to make the change in the visual properties dependent on the intensity of an electrical field present in the immediate vicinity of the transceiver antenna of the mobile radio terminal and also to apply a voltage proportional to the transmission power to the housing and to modify the visual properties by way of this voltage.

In a development of the invention, provision can be made for the electrosensitive material to be an electrosensitive plastic material. In addition to the benefit of being simple to process, the choice of an electrosensitive plastic material has the additional advantage of enabling cost-effective manufacture of the housing.

As already mentioned above, provision can be made whereby the electrosensitive material changes its color and/or its transparency under the influence of the electromagnetic radiation and/or of the electrical field and/or of the applied electrical voltage. It is thus possible for example for the electrosensitive material to change its color from green to red for example as the intensity of the electromagnetic radiation increases, or to exhibit colored streaks or to assume a more intense, “brighter” color. It is equally possible for the transparency to change, for example in such a way that the electrosensitive material becomes increasingly more opaque as the intensity of the electromagnetic radiation, of the electric field or of the applied electrical voltage increases.

In addition, as already mentioned above, provision can be made whereby the extent of the change in the visual properties of the electrosensitive material is dependent on the intensity of the electromagnetic radiation or on the field strength of the electrical field or on the magnitude of the applied electrical voltage. In respect of the processing, provision can be made whereby the electrosensitive material is capable of being processed by means of injection molding. Cost-effective production of large quantities can be achieved by this means.

It is basically possible to manufacture the entire housing out of the electrosensitive material, in particular a plastic material. It is however also conceivable, for reasons of cost, to embed the electrosensitive material in a further, preferably transparent, material. This further material can for example be more cost-effective than the electrosensitive material and thus further reduce the manufacturing costs of a communication terminal according to the invention. Polycarbonate, ADS or similar, for example, can be used as the further material.

In this context, it is also possible for the further material to exhibit a high level of stability, in particular a high degree of ruggedness, impact resistance, etc. If an electrosensitive material having a relatively unstable form, which in an extreme case can even be present in the liquid state, is embedded in a chamber formed from a stable material of the type described, then this creates greater freedom in respect of the choice of the electrosensitive material.

In one embodiment, provision can be made whereby the electrosensitive material is formed from an electrosensitive film. The electrosensitive film can, as already mentioned above, be embedded in the further material or can also be mounted on this, for example by bonding or similar means.

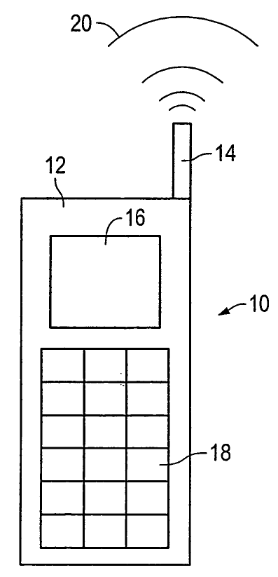

An embodiment of the invention will be described in the following with reference to the attached FIG. 1 which shows a front view of a mobile radio terminal according to the invention.

A mobile radio terminal according to the invention is referenced generally by 10 in FIG. 1. This comprises a housing 12 made of electrosensitive plastic, an antenna 14, a display 16 for displaying call-related or operation-related functions, and also a keypad 18 for controlling the device.

The housing 12 is, as previously mentioned, manufactured from an electrosensitive plastic material which changes its visual properties when electromagnetic radiation 20 of varying intensity is emitted by the antenna. This happens for example in the situation when a base station (not shown) communicating with the mobile radio terminal 10 is requested by the mobile radio terminal 10—as is the case in the GSM standard—to increase the transmission power level in order to guarantee a reliable and stable connection between the mobile radio terminal 10 and the base station.

If the intensity of the electromagnetic radiation 20 increases in the area of the mobile radio terminal 10, then for example the latter changes its color or the intensity of its color, or the transparency. The change in one or all of these visual properties is such that the user receives an unambiguous indication as to whether the emitted electromagnetic radiation is increasing or decreasing in its intensity. It is thus possible for the housing 12 of the communication terminal to change from a transparent state, representing operation at a low transmission power level, to a non-transparent (opaque) state, signaling a high intensity of electromagnetic radiation 20.

When using the mobile communication terminal 10 according to the invention it is thus possible to indicate to the user the current transmission power level being used for operating the communication terminal 10. This gives the user the capability to estimate the current SAR value (specific absorption rate) and allows him to make a decision depending on whether or not he wishes to use the communication terminal.

1-8. (canceled).

9. A mobile radio terminal, comprising:
transceiver circuitry for at least one of transmitting and receiving mobile radio signals; and
a housing at least partly encapsulating the transceiver circuitry, wherein the housing is at least partly formed of an electrosensitive material which changes its optical properties under an influence of at least one of electromagnetic radiation, an electrical field and an applied voltage.

10. A mobile radio terminal as claimed in claim 9, wherein the electrosensitive material in a electrosensitive plastic material.

11. A mobile radio terminal as claimed in claim 9, wherein the electrosensitive material changes at least one of color and transparency under the influence of the at least one of electromagnetic radiation, the electrical field and the applied electrical voltage.

12. A mobile radio terminal as claimed in claim 9, wherein an extent of the change in the optical properties of the electrosensitive material is dependent on at least one of a respective intensity of the electromagnetic radiation, a respective field strength of the electrical field and a respective magnitude of the applied electrical voltage.

13. A mobile radio terminal as claimed in claim 9, wherein the electrosensitive material is processed via injection molding.

14. A mobile radio terminal as claimed in claim 9, wherein the electrosensitive material is embedded in a further transparent material.

15. A mobile radio terminal as claimed in claim 14, wherein the further transparent material exhibits a high level of stability.

16. A mobile radio terminal as claimed in claim 14, wherein the electrosensitive material is formed from an electrosensitive film.
